(19) United States
(12) Patent Application Publication
(10) Pub. No.: US 2016/0171109 A1
(43) Pub. Date: Jun. 16, 2016

(54) WEB CONTENT FILTERING

(71) Applicant: EBAY INC., San Jose, CA (US)

(72) Inventor: Venkatesh Gnanasekaran, Cupertino, CA (US)

(21) Appl. No.: 14/569,559

(22) Filed: Dec. 12, 2014

(51) Int. Cl. G06F 17/30; G10L 17/22; G06K 9/00

(52) U.S. Cl. CPC G06F 17/30867; G06F 17/3053; G06F 17/3087; G06K 9/00288; G10L 17/22; G06K 9/00255

(57) ABSTRACT

A system may perform web content filtering in real time. In particular, the system may review and analyze the web contents, including any image, video, sound, voices, text, to identify and filter out any inappropriate for a user as the system is receiving the web content in real time. In an embodiment, the content analysis may include voice recognition, image recognition, natural language processing with multi-lingual support. Thus, the system may analyze and filter out web contents that are inappropriate for a user in real time. Further, the system may learn and build patterns of sound, image, video, text language that resemble inappropriate contents and may use the patterns to identify web contents that are not appropriate to the user.

### BACKGROUND

1. Field of the Invention

The present invention generally relates to web content filtering, and in particular, to systems and methods for implementing web content filtering.

2. Related Art

With the prevalent use of internet, many types of content are available to users online. For example, a user may utilize a search engine to find online content that the user is interested in obtaining. However, some of the online content is not appropriate to all ages of users, especially to underage users. Although some online content may be labeled or tagged to allow search engines to identify and filter out inappropriate content from underage users, some online content is not labeled or the tags or labels are not updated. As such, some inappropriate content is not filtered out and may be viewed by underage users. Therefore, there is a need for a system or method that improves the web content filtering process.

### BRIEF DESCRIPTION OF THE FIGURES

FIG. 1 is a block diagram of a networked system suitable for implementing a web content filtering process according to an embodiment.

FIG. 2 is a flowchart showing a process for setting up content filtering according to one embodiment.

FIG. 3 is a flowchart showing a process for implementing content filtering according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system may perform web content filtering in real time. In particular, the system may review and analyze web content, including any image, video, sound, voices, text, to identify and filter out any inappropriate content for a user as the system is receiving the web content in real time. In an embodiment, the content analysis may include image data matching, audio data matching, textual data matching, and the like. Thus, the system may analyze and filter out web content that is inappropriate for a user in real time. Further, in-depth analysis may be implemented including voice recognition, image recognition, natural language processing with multi-lingual support.

In an embodiment, the system may learn and build patterns of sound, image, video, textual language that resemble or is associated with inappropriate content and may use the patterns to identify web content that is not appropriate to the user. For example, the system may compare the incoming web content with the image, sound, video, and/or text patterns of inappropriate content previously learned. The system may determine that a web content is inappropriate if the web content matches closely with one or more of the patterns or data.

In an embodiment, the system may filter web content, including video content, audio content, textual content, and the like, that may be received by the system for presentation to user. In some embodiments, the system may filter out inappropriate search terms in a search engine. For example, when a user starts typing a search term at a search engine, the system may begin to suggest popular or relevant search terms and display them to the user to help the user finish typing the search term. The system may filter out inappropriate search term suggestions, such that these inappropriate search term suggestions are not displayed to the user.

In an embodiment, the system may detect or determine an audience of the web content and may select and apply appropriate web filter based on the audience. In particular, the system may determine who is currently viewing or listening to the web content, such as who is currently sitting in front of a web browser, and may select a filter based on who the person is. For example, the system may detect one or more users by one or more of a camera, a microphone, and a wireless communication device that detects the presence of the users' mobile devices. The system may analyze and determine the identities of the users who are near or in front of the web browser by facial recognition, voice recognition, device identification, or the like, and may filter the web contents based on the audience of the web contents. Once one or more users are identified as viewing a display, profiles about the users may be accessed to determine what is appropriate or not appropriate. For example, a child A may have certain restrictions on content placed by child A's parents that are different than restrictions for a child B, even though child A and child B may be of the same age and gender. Profiles may be set by parents or others or be set by a service provider, such as based on what the user has been allowed to view.

In an embodiment, the system may detect a location or an environment around the web browser and may select and apply an appropriate content filter based on the detected location or environment. For example, the system may detect, via Global Positioning System (GPS), that the web browser is currently located at a work place of a user. As such, the system may select and apply a content filter that filters out contents that are not appropriate or not safe for work (NSFW). Thus, the system may select the appropriate content filter based on one or more of the location of the web browser, the audience of the web browser, and may filter the web content in real time by comparing the web content with previously established patterns of inappropriate content.

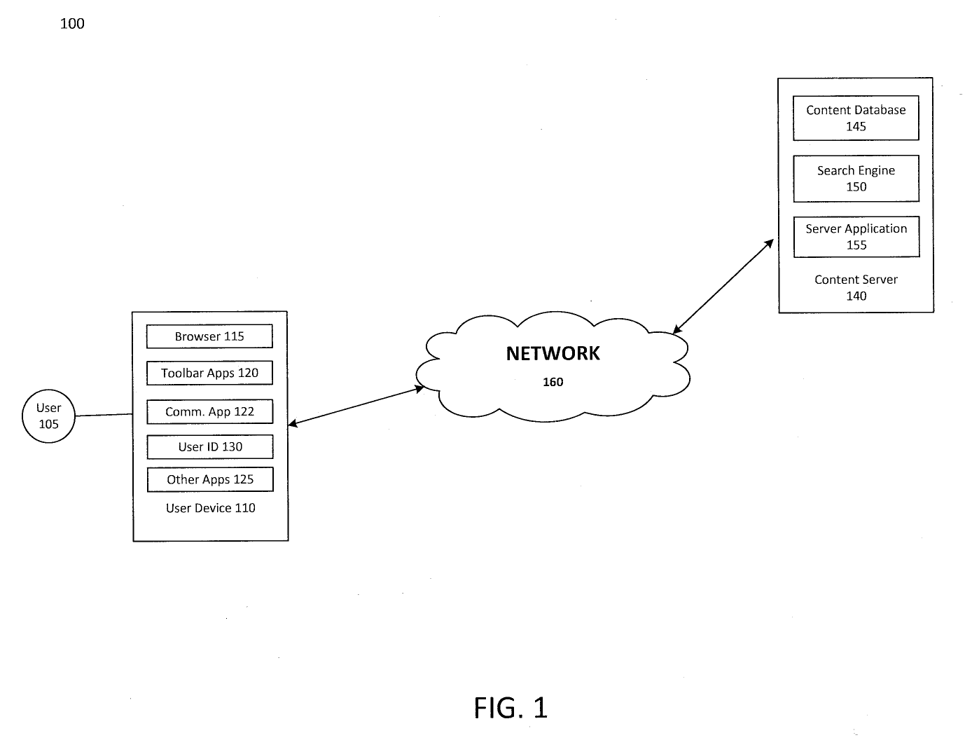

FIG. 1 is a block diagram of a networked system 100 configured to implement a process for web content filtering in accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110 and a content server 140 in communication over a network 160. The content server 140 may be maintained by a content provider who provides online content, such as individuals, software companies, search engines, online portals, or any entities or organizations that post or provide content via the internet. A user 105, such as a consumer, may utilize user device 110 to request content, such as textual content, image content, video content, audio content, and the like, from the content server 140. For example, user 105 may utilize user device 110 to visit a web site hosted by the content server 140 to browse for information or items presented or posted on the web site. Further, user 105 may utilize user device 110 to initiate a search for particular information and receive results of the search. Although only one content server is shown, a plurality of content servers may be implemented.

User device 110 and content server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks. User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to search and browse information available over network 160. For example, in one embodiment, browser application 115 may be implemented as a web browser configured to view information available over the Internet, such as online content, websites for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, or make payments. Further, user device 110 may include one or more user identifiers 130 which may be implemented, for example, as operating system registry entries, cookies associated with browser application 115, identifiers associated with hardware of user device 110, or other appropriate identifiers, such as used for payment/user/device authentication. A communications application 122, with associated interfaces, enables user device 110 to communicate within system 100.

Content server 140 may be maintained, for example, by an online content provider, such as a web hosting service provider. Content server 140 may include a content database 145 identifying available content and information which may be made available for viewing or listening by user 105. For example, content database 145 may include a content index accessible by search engines. Content server 140 also may include a search engine 150 configured to search for relevant content or information requested by the user 105. In one embodiment, user 105 may interact with the search engine 150 through browser applications over network 160 in order to search and view various content and information identified in the content database 145. User 105 may use user device 110 to send search queries to content server 140. In response, content server 140 may search for content and return search results to user device 110. Content server 140 also may include a server application 155 configured to facilitate various functions of the content server 140, such as indexing, storing, updating, and managing various content.

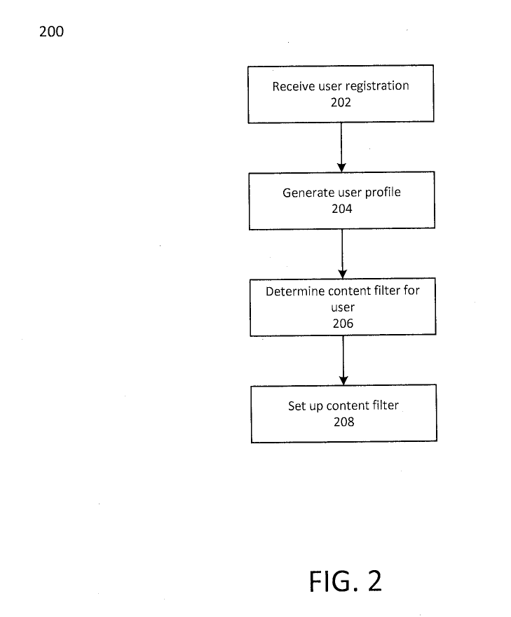

FIG. 2 is a flowchart showing a process 200 for setting up web content filtering according to one embodiment. At step 202, the user device 110 or the content server 140 may receive registration. For example, the user 105 may register to establish a user account to receive content from the content server 140. The user 105 may provide various personal information, including user name, password, name, address, phone number, email address, contact information, age, gender, and other information that may identify the user 105. In an embodiment, the user 105 may identify other users with whom the user 105 shares the use of the user device 110 or other users with whom the user 105 may view or listen to web content together. In an embodiment, the user 105 may identify and register other devices, such as mobile phones, smart watches, laptop computers, desktop computers, other wearable devices, that are owned or operated by the user 105 and may connect to the user device 110. The user 105 also may identify other devices carried by or owned by other users related to user 105 who may view or listen to web content with the user 105.

At step 204, the system may generate a user profile based on information provided by the user 105. The system also may ask for the user 105's interests and preferences in web content. For example, the user 105 may designate preferences for content categories, such as music styles, categories in sports, news, and the like. The system also may ask the user 105 to identify the type of content that the user 105 does not want to be shown, such as content involving sex, violence, language, and the like. In another embodiment, the system may infer the inappropriate content based on the user 105's age. For example, the system may utilize the film rating system to define standards for appropriate or inappropriate content based on the user 105's age, such as G for general audiences, PG for parental guidance, PG-13, R for restricted, and the like. The system may also utilize. Television Ratings, such as TV-Y, TV-Y7, TV-G, TV-PG, and the like.

At step 206, the system may determine a content filter for the user 105 based on the user 105's input. The content filter may be defined based on the user 105's age. In another embodiment, the content filter may be defined based on the user 105's input and preferences. In an embodiment, the user 105 may have different content filters for different locations or different environments. For example, the user 105 may have a content filter for the user 105's work place that filters, out non-professional content or content that is not appropriate for work. The user 105 may have different content filters based on who else also is viewing or listening to the web content with the user 105. For example, the user 105 may have a content filter for when the user 105 is viewing web content with the user 105's child.

At step 208, the system may set up the content filter for the user 105. The content filter may then be used to filter out non-desirable or inappropriate content when the user 105 is browsing on the web or conducting searches using search engines. The user 105 may set how the content filter should be used. For example, the user 105 may set different content filters for different locations, different audiences, different time and/or day, different seasons, or different contexts.

In an embodiment, the user 105 may train or customize a content filter based on the user 105's use experience. In particular, when the user 105 is viewing or listening to various web content, the system may allow the user 105 to indicate whether a web content is inappropriate or is undesirable for certain situation. For example, when the user 105 is conducting a search at work, the user 105 may label unprofessional search suggestions or search results as inappropriate for work. As such, the system may learn the type of content that the user 105 does not wish to see when the user 105 is at work. The system may continuously learn and update the content filter at work. The system may collect and recognize image patterns, textual keywords, audio signal wave patterns that resemble the inappropriate or undesirable content and may continuously update the patterns to improve the accuracy of recognizing the inappropriate or undesirable content. In an embodiment, the system may analyze the web content by voice recognition and natural language processing with multilingual support. As such, the system may analyze patterns across different languages. The system may allow the user 105 customize a content filter based on the user 105's desire or needs. For example, the user 105 may create a customized filter that filters out web content that is inappropriate or offensive to the user 105's personal beliefs, ethnic, or cultural background. The user 105 also may create a customized filter that filters out web content that is inappropriate to certain family members, such as children, parents, and the like.

By using the above process 200, content filters may be set up for the user 105. The content filters may be customized based on the user 105's preferences, age, user 105's locations, audiences, and the like. In particular, the system may learn and update the content filters based on the user 105's input. Thus, dynamic web content filters may be created and customized based on the user 105's needs. Filters may be set up based on one or a combination of data discussed herein.

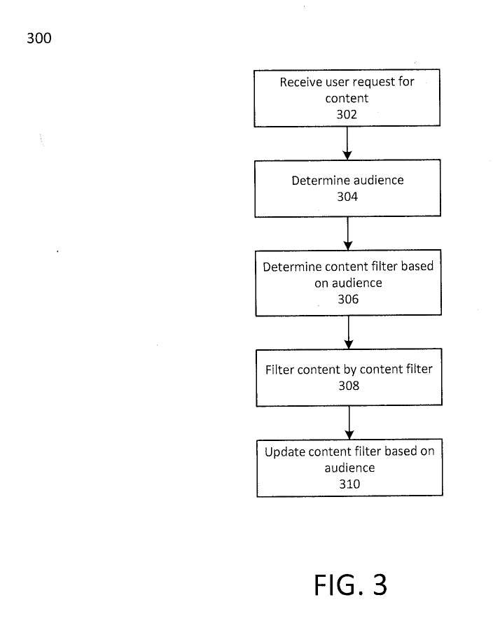

FIG. 3 is a flowchart showing a process 300 or implementing content filtering according to one embodiment. At step 302, the user device 110 or the content server 140 may receive the user 105's request for content. In an embodiment, the user 105 may utilize a search engine to search for content by entering search terms. In another embodiment, the user 105 may enter the web address of the content the user 105 wishes to request. In still another embodiment, the user 105 may click on certain URL links or execute an application that requests content for the user 105.

At step 304, the system may determine who the audience is for the requested content. In an embodiment, the system may determine who the audience is based on the identity of the person who is currently logged into the system. In another embodiment, the user device 110 at which the user 105 is requesting the web content may include a camera configured to capture facial images of the person or people at the user device 110. Facial recognition techniques may be used to determine the identity of the person or persons at the user device 110 to determine the audience. For example, based on the positions of the eyes, noise, and mouth in proportion to the size of the face, the system may determine whether the person or persons are underage, such as young children.

In still another embodiment, the user device 110 may include an audio sensor configured to capture voices spoken by the person or persons at the user device 110. The system may utilize voice recognition techniques to determine the identity of the person or persons at the user device 110 to determine the audience. In an example, based on the voice pitch and speech pattern of the detected voices, the system may determine whether the person or persons are underage, such as young children.

In an embodiment, the user device 110 may detect other nearby devices wirelessly, such as by BLE or WiFi communication. Based on the connections to nearby devices, the system may determine who is near the user device 110. For example, if the user device 110 detects that the user 105's smart watch is connected to the user device 110 and also that the user 105's co-worker's smart phone also is nearby, the system may determine that the user 105 is probably at work and that the audience may include both the user 105 and the user 105's co-workers.

At step 306, the system may determine or select the content filter based on the audience. In particular, the user 105 may have different content filters that are applicable to different situations or audiences. For example, the user 105 may have a content filter for work, a content filter for home, a content filter for viewing with children, and the like. The system may automatically select a content filter based on the person or persons detected at the user device 110 or the audience determined by the system. In an embodiment, the system may suggest a content filter to the user 105 and the user 105 may accept or confirm the use of that suggested content filter.

In an embodiment, the system also may select a content filter based on the location detected at the user device 110. In particular, the user device 110 may include a location detection device, such as a GPS device, a Bluetooth Low Energy (BLE) device, or the like that allow the system to detect the location and movement of the user device 110. Based on the user device 110's location, the system may select a filter for the location or environment. For example, the system may select different content filters based on when the user 105 is at work, at school, at home, traveling, and the like.

In an embodiment, the system also may select a content filter based on the time of the day, the day of the week, the month or season of the year. In particular, based on the user 105's calendar or schedule, the system may determine the user 105's environment or events and may select appropriate content filter(s) based on the user 105's events or environment. Different content filters may be used for when the user 105 is at work during business hours, at home after work, at a religious event on weekends, or during certain cultural holidays of the year when particular content filters should be used to filter out inappropriate or offensive content.

In an embodiment, the system also may select a content filter based on a type of language spoken around the user device 110. In particular, the user device 110 may include an audio sensor configured to capture voices and spoken words around the user device 110. The system may analyze the voices and spoken words using voice recognition and natural language processing to determine the type of language spoken. The system may then select a content filter that is appropriate for the spoken language and the cultural, ethnic, and/or religious backgrounds associated with the spoken language.

Thus, selecting the appropriate content filter(s) may depend on one or more of a user profile, user location, time of day, day of year, and language. Once an identity of a user or users is determined, a database may be accessed and/or searched to find information about the user(s). Based on one or more of the various factors discussed herein, one or more appropriate content filters may be retrieved.

At step 308, the user device 110 or the content server 140 may begin to filer content based on the selected or determined content filter. In an embodiment, multiple content filters may be selected and may be utilized in combination for filtering content. Each content filter may include one or more content patterns, such as image patterns, audio signal patterns, textual patterns or keywords that are designated as inappropriate or non-desirable. The system may continuously match the incoming web content with the designated patterns in the content filters in real time. When the incoming content match the patterns or data in the content filers, the incoming content may be filtered out or blocked from being viewed or heard by the user 105 or other audiences. In another embodiment, the user may be shown a warning for the inappropriate content, which the user can override (if the user has such authority to do so) and view the inappropriate content. With no affirmative authorization, inappropriate is otherwise blocked or not viewable and/or hearable by the user.

In an embodiment, a plurality of content filters may be used to filter the incoming content received by the user device 110 or sent to the user device 110. The content filters may include video patterns, image patterns, audio signal wave patterns, textual keywords, textual patterns, and the like. These patterns may resemble images, videos, music, audio sounds, or textual words or phrases that are inappropriate or undesirable to the user 105. The system may first determine the type of incoming content. For example, the system may determine whether the incoming content contains video data, image data, audio data, and/or textual data. The system may then select the content filter based on the type of incoming data. For example, if the incoming content includes audio data, the system may select content filters with audio signal wave patterns. If the incoming content includes video data, the system may select content filters with image or video patterns.

The system may compare the incoming content with the patterns of the content filters and may calculate a similarity score from the comparison. When the similarity score exceeds a certain threshold, the system may filter out or block the incoming content from being viewed or heard by the user 105. In an embodiment, the system may flag the incoming content for further analysis. The comparison process may be a relatively quick process in which the incoming content is compared against the various patterns of the content filters without conducting in-depth analysis of the incoming content. Because the filtering is conducted by pattern matching without in-depth analysis, the system may seamlessly process and filter the incoming content in real time without noticeable delay to the user 105. At a later time, the system may conduct more in-depth analysis of the incoming content that is flagged by the content filter. The flagged contents may be presented to the user 105 later if the in-depth analysis finds the flagged content contains no inappropriate material.

When certain content is determined as inappropriate based on the content filters, the system may mask or block the content. A message or a notification also may be displayed in place of the content indicating that the content is masked or blocked as inappropriate for the audience and the reason. For example, certain content may be blocked as inappropriate for children or offensive to certain ethnic or cultural backgrounds. The system may allow the user 105 to unmask or unblock the content after user authentication by the user 105, such as by entering a PIN or username and password. In an embodiment, the system may allow the user 105 to provide feedback on the masked or blocked content. For example, the user 105 may provide feedback indicating that the masked or blocked content should not be designated as inappropriate. The system may use the user 105's feedback to update and improve the content filters to improve their accuracy in identifying inappropriate content.

At step 310, the system may continue to update the content filters based on the audience or the location of the user 105. In particular, the system may continuously monitor the audience of the web browser by camera; audio sensor, and the like. If the audience changes, the system may update and change the content filters accordingly. For example, the user 105 is conducting web searches alone on the user device 110. The system may select content filters that are less restrictive. When the system detects by audio sensor or by camera that the user 105's children appear in front of the user device 110, the system may automatically update or change to more restrictive content filters that filter out inappropriate content for children.

In another example, the user 105 may be viewing personal information on the user device 110 at work. The system may select content filters that allow personal information. When the system detects that a mobile device of the user 105's supervisor is approaching the user 105, the system may update and change to content filters that filter out personal information and allow work-related information. As such, personal information of the user 105 is kept private from others at work. In still another example, the user 105 may be attending an event at a cultural or religious location. The system may detect that the user 105 has arrived at the cultural or religious location and may update and change the content filters that filter out content that is inappropriate or offensive to the cultural or religious location.

The above processes 200 and 300 may be executed at content server 140. In one embodiment, one or more steps of processes 200 and 300 may be executed by user device 110. In another embodiment, one or more steps of processes 200 and 300 may be executed by the user device 110 and the content server 140 in coordination with each other.

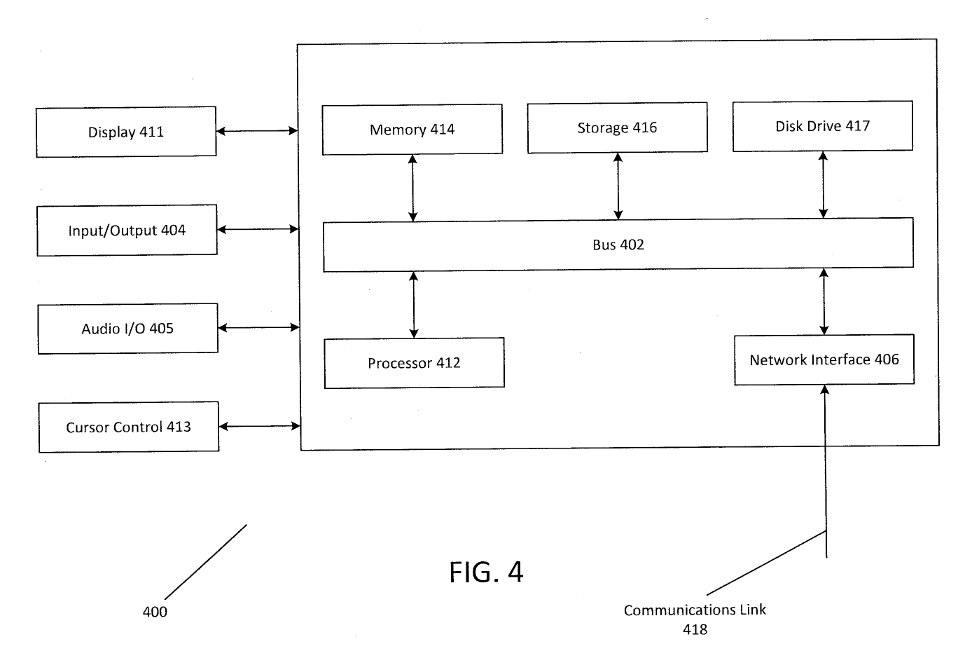

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant device, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one′ example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented-as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems; networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing an account of a user; and
one or more processors in communication with the memory and adapted to:
receive a request from the user for content;
detect an audience at a user device of the user;
determine a content filter for the content based on the audience, wherein the content filter is configured to filter out content that matches data patterns designated by the content filter as inappropriate for the audience;
filter the content with the content filter; and
present the filtered content to the user.

2. The system of claim 1, wherein the one or more processors are further adapted to:
compare data of the content with the data patterns of the content filter;
determine a similarity score between the data of the content and the data patterns; and
filter the data of the content when the similarity score exceeds a threshold.

3. The system of claim 2, wherein the one or more processors are further adapted to:
determine a data type of the content; and
select a content filter including a data pattern that matches the data type of the content.

4. The system of claim 3, wherein the data type of the content comprises one or more of a video data type, an image data type, an audio data type, and a textual data type.

5. The system of claim 2, wherein the one or more processors are further adapted to conduct natural language analysis of the data of the content that is filtered by the content filter.

6. The system of claim 1, wherein the one or more processors are further adapted to masking or blocking the filtered content from the user.

7. The system of claim 6, wherein the one or more processors are further adapted to present a notification or a reason for masking or blocking the filtered content.

8. The system of claim 1, wherein the one or more processors are further adapted to:
receive a user feedback on the filtered content; and
update the content filter based on the user feedback.

9. The system of claim 1, wherein the one or more processors are further adapted to:
detect facial images of the audience by a camera at the user device; and
determine identities of the audience based on the facial images by facial recognition techniques.

10. The system of claim 1, wherein the one or more processors are further adapted to:
detect voices of the audience by an audio sensor at the user device; and
determine identities of the audience based on the voices by voice recognition techniques.

11. The system of claim 1, wherein the one or more processors are further adapted to:
detect communication devices carried by the audience; and
determine identities of the audience based on the communication devices detected.

12. The system of claim 1, wherein the one or more processors are further adapted to:
continuously monitor the audience at the user device;
determine a change in the audience at the user device; and
update the content filter based on the change in the audience.

13. The system of claim 1, wherein the one or more processors are further adapted to:
detect a location of the user device; and
determine the content filter based on the location.

14. The system of claim 13, wherein the one or more processors are further adapted to:
continuously monitor the location of the user device;
determine a change in the location of the user device; and
update the content filter based on the change in the location.

15. A method comprising:
receiving, by one or more processors, a request from a user for content;
detecting, by the one or more processors, an audience at a user device of the user;
determining, by the one or more processors, a content filter for the content based on the audience, wherein the content filter is configured to filter out content that matches data patterns that is designated by the content filter as inappropriate for the audience;
filtering, by the one or more processors, the content with the content filter; and
presenting, by the one or more processors, the filtered content to the user.

16. The method of claim 15, wherein the audience includes underage person and the content filter is configured to filter out material in the content that matches data patterns designated by the content filter as inappropriate for underage person.

17. The method of claim 15 further comprising:
detecting a location of the user device; and
determining the content filter based on the location.

18. The method of claim 17, wherein the location is associated with a cultural, religious, or ethnic entity and the content filter is configured to filter out material in the content that matches data patterns designated by the content filter as offensive or inappropriate to the cultural, religious, or ethnic entity.

19. The method of claim 15 further comprising:
detecting, by a camera, facial images of the audience;
analyzing facial features of the facial images;
determining that the facial images contain a facial image of an underage person; and
filtering out materials from the content that matches data patterns designated by the content filter as inappropriate for underage persons.

20. The method of claim 15 further comprising:
detecting, by an audio sensor, voices of the audience;
analyzing pitches and speech patterns of the voices;
determining that the voices contain that of an underage person; and
filtering out materials from the content that matches data patterns designated by the content filter as inappropriate for underage persons.
